(19) United States
(12) Patent Application Publication
(10) Pub. No.: US 2023/0419780 A1
(43) Pub. Date: Dec. 28, 2023

(54) METHOD FOR PROVIDING ONLINE GAME SERVICE AND ELETRONIC DEVICE THEREFOR

(71) Applicant: Do Heon Shin, Yongin-si (KR)

(72) Inventor: Do Heon SHIN, Yongin-si (KR)

(21) Appl. No.: 17/952,003

(22) Filed: Sep. 23, 2022

(30) Foreign Application Priority Data
Jun. 24, 2022 (KR) 10-2022-0077666

(51) Int. Cl. G07F 17/32

(52) U.S. Cl. CPC G07F 17/3244

(57) ABSTRACT

Provided is a method for providing an online game service, including receiving an application to participate in a game conditional on a participation fee from terminals of a plurality of players, identifying information about the plurality of players participating in the game, identifying first players who are winners and second players who are losers from among the plurality of players based on a play result of each of the plurality of players in the game, and providing the first players with a first amount of withdrawable first tokens, and providing the second players with the first amount of non-withdrawable second tokens, and provided is an electronic device therefor.

### CROSS-REFERENCE TO RELATED APPLICATION

This application claims the benefit of Korean Patent Application No. 10-2022-0077666, filed on Jun. 24, 2022, in the Korean Intellectual Property Office, the disclosure of which is incorporated herein by reference.

### BACKGROUND

### Technical Field

Example embodiments relate to a method and an electronic device for providing an online game service.

### Description of the Related Art

Online games in which users can access game servers and play games together are becoming popular. In order to activate an online game, there is a need to motivate users so that they may continuously play the game. In addition, there is a need for a system in which users can play the game more fairly.

Meanwhile, blockchain technology, one of the core technologies of the 4^{th} industrial revolution, is currently being used in various fields such as financial services and game services based on reliability and stability.

### BRIEF SUMMARY

An aspect provides a method and an electronic device for providing an online game service. The technical problems to be achieved by the present disclosure are not limited to the technical problems described above, and other technical problems may be inferred from the following example embodiments.

According to an aspect, there is provided a method by which an electronic device provides an online game service, including receiving an application to participate in a game conditional on a participation fee from terminals of a plurality of players, identifying information about the plurality of players participating in the game, identifying first players who are winners and second players who are losers from among the plurality of players based on a play result of each of the plurality of players in the game, and providing the first players with a first amount of withdrawable first tokens, and providing the second players with the first amount of non-withdrawable second tokens, wherein the providing includes converting the first amount of first tokens among participation fees of the second players into non-withdrawable tokens.

According to another aspect, there is provided an electronic device for providing an online game service, including a memory in which at least one program is stored and a processor, which is configured to, by executing the at least one program, receive an application to participate in a game conditional on a participation fee from terminals of a plurality of players, identify information about the plurality of players participating in the game, identify first players who are winners and second players who are losers from among the plurality of players based on a play result of each of the plurality of players in the game, and provide the first players with a first amount of withdrawable first tokens, and provide the second players with the first amount of non-withdrawable second tokens, wherein the processor is configured to convert the first amount of first tokens among participation fees of the second players into non-withdrawable tokens.

According to another aspect, there is provided a computer-readable non-transitory recording medium recording a program for executing the method described above on a computer.

Additional aspects of example embodiments will be set forth in part in the description and drawings which follow and, in part, will be apparent from the description and drawings, or may be learned by practice of the disclosure.

According to example embodiments, when the electronic device provides tokens as a reward to a plurality of players participating in the game, it is possible to newly issue the first tokens of the first amount provided to the first players who are winners, and by converting the first amount of first tokens among the participation fees of the second players who are the losers into non-withdrawable tokens, the value of the newly issued first tokens may be maintained as it is, thereby preventing inflation.

According to the present disclosure, an electronic device enables a plurality of players to play a game fairly by monitoring each other by introducing a system related to a judgment for determining whether a specific player abused the game in response to a report of suspicion. In particular, since an electronic device 10 determines whether or not a specific player has been abusing the game in the judgment based on determination results from the participants, it is possible to more objectively determine whether the specific player has been abusing the game. Further, since the participation fee for the game is provided to the player who reported the suspicion or the player who received the suspicion according to a determination result, it is possible to prevent a plurality of players from indiscriminately reporting suspicion, the participation fee for the game is provided to the participants according to the determination result, so the participation rate of the participants may be increased, and the participants may be motivated to make more fair judgments.

Further, as the electronic device introduces a system for a second judgment, which is a judgment against the result of the first judgment, or a third judgment, which is a judgment against a result of the second judgment, it is possible to make a more fair judgment as to whether a specific player abused the game.

The effect of the present disclosure is not limited to the effect stated above, and other effects not stated will be clearly understood by those skilled in the art from the description of the claims.

### BRIEF DESCRIPTION OF THE SEVERAL VIEWS OF THE DRAWINGS

These and/or other aspects, features, and advantages of the disclosure will become apparent and more readily appreciated from the following description of example embodiments, taken in conjunction with the accompanying drawings of which:

FIG. 1 illustrates a system for providing an online game service according to an example embodiment;

FIG. 2 is a flowchart illustrating an example embodiment of a method for an electronic device to provide an online game service;

FIG. 3 is a flowchart illustrating an example embodiment in which an electronic device provides a first token to a first player using a blockchain network;

FIG. 4 is a flowchart illustrating an example embodiment in which an electronic device provides a second token to a second player using a blockchain network;

FIG. 5 is a flowchart illustrating an example embodiment in which an electronic device determines whether a player abused a game;

FIG. 6 is a flowchart illustrating an example embodiment in which an electronic device determines whether a player abused a game;

FIG. 7 is another flowchart illustrating an example embodiment in which an electronic device determines whether a player abused a game; and

FIG. 8 is a block diagram of an electronic device.

### DETAILED DESCRIPTION

Terms used in the example embodiments are selected as currently widely used general terms as possible while considering the functions in the present disclosure. However, the terms may vary depending on the intention or precedent of a person skilled in the art, the emergence of new technology, and the like. Further, in certain cases, there are also terms arbitrarily selected by the applicant, and in the cases, the meaning will be described in detail in the corresponding descriptions. Therefore, the terms used in the present disclosure should be defined based on the meaning of the terms and the contents of the present disclosure, rather than the simple names of the terms.

Throughout the specification, when a part is described as “comprising or including” a component, it does not exclude another component but may further include another component unless otherwise stated. Furthermore, terms such as “ . . . unit,” “ . . . group,” and “ . . . module” described in the specification mean a unit that processes at least one function or operation, which may be implemented as hardware, software, or a combination thereof.

In the present disclosure, a “terminal” may be implemented as, for example, a computer or a portable terminal capable of accessing a server or another terminal through a network. Here, the computer may include, for example, a notebook, a desktop computer, and/or a laptop computer which are equipped with a web browser. The portable terminal may be a wireless communication device ensuring a portability and a mobility, and include (but is not limited to) any type of handheld wireless communication device, for example, a tablet PC, a smartphone, a communication-based terminal such as international mobile telecommunication (IMT), code division multiple access (CDMA), W-code division multiple access (W-CDMA), long term evolution (LTE), or the like.

Hereinafter, example embodiments of the present disclosure will be described in detail with reference to the accompanying drawings so that those of ordinary skill in the art to which the present disclosure pertains may easily implement them. However, the present disclosure may be implemented in multiple different forms and is not limited to the example embodiments described herein.

Hereinafter, example embodiments of the present disclosure will be described in detail with reference to the drawings.

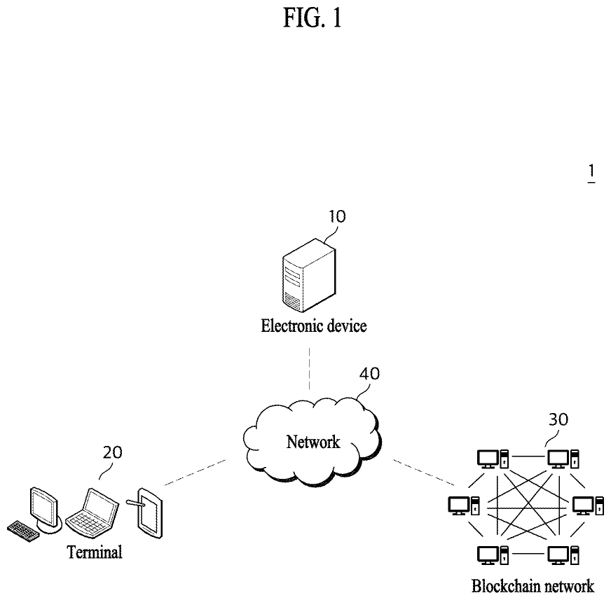

FIG. 1 illustrates a system for providing an online game service according to an example embodiment.

Referring to FIG. 1, a system 1 may include the electronic device 10, a terminal 20 and a blockchain network 30. In the system 1 illustrated in FIG. 1, only the components related to the example embodiment are shown. Therefore, it can be understood by those of ordinary skill in the art related to the present disclosure that other general-purpose components may be further included in addition to the components illustrated in FIG. 1.

The electronic device 10, the terminal 20 and the blockchain network 30 may communicate with each other within a network 40. The network 40 includes a local area network (LAN), a wide area network (WAN), a value added network (VAN), a mobile radio communication network, a satellite communication network, and a mutual combination thereof. The network 40 is a data communication network in a comprehensive sense that enables each network constituent entity shown in FIG. 1 to communicate smoothly with each other, and the network 40 may include a wired Internet, a wireless Internet and a mobile wireless communication network. Wireless communication is, for example, wireless LAN (Wi-Fi), Bluetooth, Bluetooth low energy, ZigBee, Wi-Fi Direct (WFD), ultra wideband (UWB), infrared data association (IrDA) and near field communication (NFC), but it is not limited thereto.

The electronic device 10 may provide an online game service. The electronic device 10 may provide an application to execute a game to the terminal 20, and the terminal 20 may be provided with the game service by executing the application. For example, the electronic device 10 may be included in a server that provides a game service, and the terminal 20 may be a client accessing the server. The electronic device 10 may provide a game in which a plurality of players can participate. Here, the game may refer to a game in which a plurality of players compete to determine a winner or loser according to a game-specific rule. Further, the game may refer to a game in which a plurality of players compete to determine rankings of the plurality of players according to the game-specific rule. For example, the game may be a league-type game or a tournament-type game. For example, the game may be a game in which the rankings of the plurality of players are determined in the order of the players who acquire the most specific items in a specific map. The electronic device 10 may provide a plurality of games through a game platform, and may set a purpose, a rule, a participation fee and a reward distribution rule differently for each of the plurality of games.

The electronic device 10 may provide an online game service based on a token economy. The token economy may indicate an economic structure in which appropriate rewards are provided to token ecosystem participants according to their levels of participation. According to the token economy, actions of the participants may be induced by rewarding the participants with tokens, and the token may have a value that can be exchanged for other types of goods or other services. The electronic device 10 may provide tokens to players participating in a game as an incentive.

The terminal 20 may be a terminal of a game user or a player who plays the game. The player may play the game through a specific character in the game. For example, the player may have at least one character in the player's game account, and may participate in the game through the possessed character.

The blockchain network 30 may include a plurality of nodes operating based on the blockchain technology. The blockchain technology may refer to a distributed ledger technology in which the ledger that records transaction information is distributed to a P2P network rather than a central server of a specific institution, and nodes in the network record and manage it jointly. For example, the nodes may be a special-purpose computer, a general-purpose computer, a supercomputer, a mainframe computer, a personal computer, a smart phone and a tablet PC, but the nodes are not limited thereto. The blockchain network 30 may store the information, transaction, or smart contract transmitted from the electronic device 10 in the form of a block based on a predetermined (or selected) consensus algorithm. According to an example embodiment, the consensus algorithm performed in the blockchain network 30 may include a proof of work (PoW) algorithm, a proof of stake (PoS) algorithm and a delegated PoS (DPoS) algorithm, but the consensus algorithm is not limited thereto.

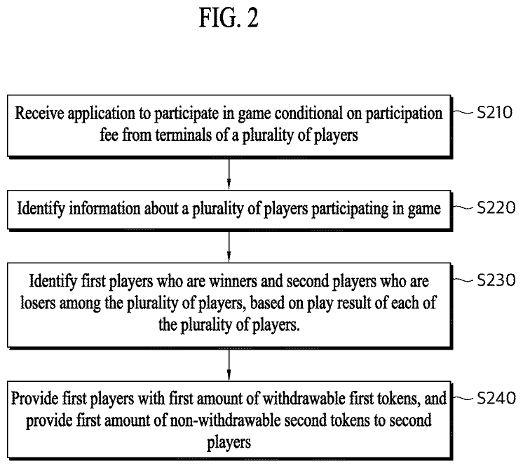

FIG. 2 is a flowchart illustrating an example embodiment of a method for an electronic device to provide an online game service.

In operation S210, the electronic device 10 may receive an application to participate in a game conditional on a predetermined (or selected) participation fee from terminals of a plurality of players. In other words, each of the plurality of players may participate in the game provided by the electronic device 10 through the terminal on condition of the participation fee determined in the game. The participation fee may be a predetermined (or selected) number of tokens. For example, the participation fee may be a predetermined (or selected) amount of first tokens and a predetermined (or selected) amount of third tokens that are a stable coin. Herein, a stable coin may refer to a cryptocurrency issued with a fixed value to a real currency (for example, the dollar), for example, the UDS coin (USDC). The participation fee may be set to include a certain percentage a stable coin for the purpose of stabilizing the market price or circulation price of the first token.

In operation S220, the electronic device 10 may identify information about the plurality of players participating in the game. The electronic device 10 may identify information about tokens held by each of the plurality of players. According to an example embodiment, the electronic device 10 may identify a blockchain account (or a blockchain address) of each of the plurality of players, and may identify information about the tokens held by each of the plurality of players. The blockchain account may function as a wallet holding tokens, and the blockchain account may be managed by the blockchain network 30. The electronic device 10 may receive information about the blockchain account of each of the plurality of players from the terminals of the plurality of players, and when the plurality of players participate in the game, a predetermined (or selected) amount of tokens may be identified as a participation fee in the blockchain account of each of the plurality of players. According to an example embodiment, the electronic device 10 may perform staking on the participation fee of each of the plurality of players while the plurality of players participate in the game. Specifically, the electronic device 10 may deposit the participation fee of each of the plurality of players in the blockchain network so that the participation fee may be utilized for the blockchain network operation, and the electronic device 10 may receive a profit compensation in return. The electronic device 10 may provide the profit compensation to the plurality of players.

In operation S230, the electronic device 10 may identify first players who are winners and second players who are losers among the plurality of players, based on a play result of each of the plurality of players.

The electronic device 10 may identify the ranking of each of the plurality of players based on information about the play result of each of the plurality of players, and may classify the plurality of players into first players who are winners and second players who are losers based on the rankings. The ratio of winners and losers among the plurality of players may be settable by a user or a game operator. For example, when the number of players participating in the game is 100, the electronic device 10 may identify players ranked the first to the eightieth as the first players who are winners, and players from the eighty first to the hundredth as the second players who are losers.

In operation S240, the electronic device 10 may provide the first players with a first amount of withdrawable first tokens, and may provide the first amount of non-withdrawable second tokens to the second players. A withdrawable token may indicate a token that can be withdrawn from a blockchain account to another blockchain account, or a token that can be exchanged for another type of token or coin. A non-withdrawable token may indicate a token that cannot be withdrawn from a blockchain account to another blockchain account, or a token that cannot be exchanged for another type of token or coin. For example, a token locked-up in a blockchain account may be a non-withdrawable token, and a token that is not locked-up in a blockchain account may be a withdrawable token. The electronic device 10 may provide a first amount of first tokens to the first players as a reward for participating in a game, and provide the first amount of second tokens to the second players.

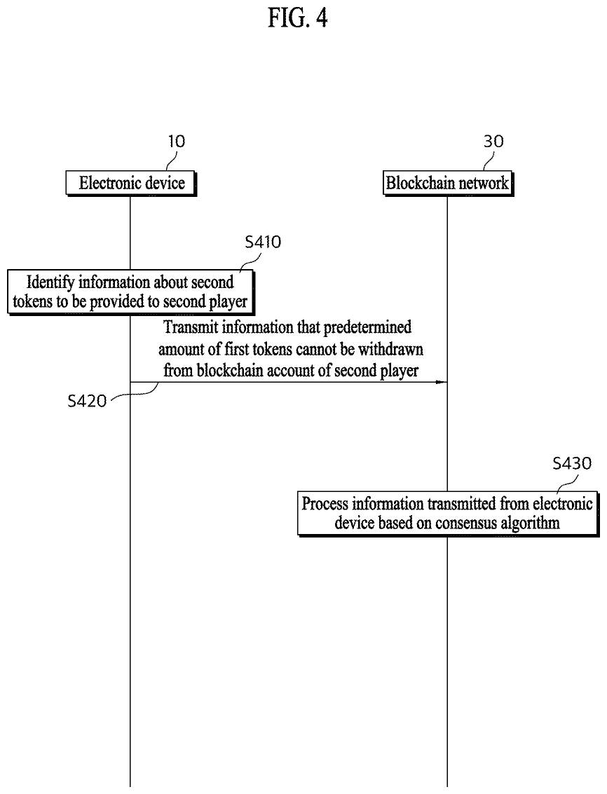

The electronic device 10 may convert the first amount of first tokens among the participation fees of the second players into non-withdrawable tokens to provide the second players with the first amount of second tokens. The electronic device 10 may change the state of the first tokens from the withdrawable state to the non-withdrawable state, and provide the non-withdrawable first tokens as second tokens to the second players. A predetermined (or selected) amount of first tokens among the participation fee of each of the second players may be converted into the predetermined (or selected) amount of second tokens, and as a result, after the game ends, each of the second players may lose the predetermined (or selected) amount of the first tokens from the participation fee and obtain the predetermined (or selected) amount of the second tokens. For example, the electronic device 10 may convert a second amount of first tokens among the participation fee of a 2-1 player into non-withdrawable tokens, and provide the second amount of second tokens to the 2-1 player, and the electronic device 10 may convert a third amount of first tokens among the participation fee of a 2-2 player into non-withdrawable tokens, and may provide the third amount of second tokens to the 2-2 player. According to an example embodiment, the electronic device 10 may convert a predetermined (or selected) amount of first tokens among the participation fee of each of the second players into non-withdrawable tokens by using the blockchain network. A specific example embodiment will be described below with reference to FIG. 4.

According to an example embodiment, the electronic device 10 may provide the same amount of second tokens to each of the second players, and may distribute a first amount of first tokens to the first players based on the rankings of the first players according to the play result of the game. In this case, the first amount may be a value obtained by multiplying the number of second players by the number of second tokens provided to each of the second players. For example, when the number of first players is 80, the number of second players is 20, and the amount of second tokens provided to each of the second players is 10, the electronic device 10 may provide 200 withdrawable first tokens which is the first amount to the first players and may provide 200 non-withdrawable second tokens which is the first amount to the second players. The electronic device 10 may convert ten first tokens held by each of the second players into non-withdrawable tokens, and provide the ten second tokens to each of the second players. In other words, the ten first tokens held by each of the second players may be converted into ten second tokens. The electronic device 10 may provide 200 first tokens to the first players based on the rankings of the first players so that more first tokens are provided to the first players with high rankings. For example, three first tokens may be provided to each of the first players ranked from the first to the fortieth, and two first tokens to each of the first players ranked from the forty first to the eightieth.

According to another example embodiment, based on the rankings of the first players and the rankings of the second players according to the play result of the game, the electronic device 10 may distribute a first amount of first tokens to the first players and distribute a first amount of second tokens to the second players. The electronic device 10 may distribute a first amount of first tokens to the first players so that more first tokens are provided to a first player with a high ranking, and distribute the first amount of second tokens to the second players so that more second tokens are provided to a second player with a lower ranking. For example, when the number of first players is 80, the number of second players is 20 and the first amount is 200, the electronic device 10 may provide three first tokens to each of the first players ranked from the first to the fortieth, provide two first tokens to each of the first players ranked from forty first to the eightieth, provide five second tokens to each of the second players ranked from the eighty first to the ninetieth, and provide 15 second tokens to each of the second players ranked from the ninety first to the hundredth.

The electronic device 10 may provide a first amount of first tokens to the first players by newly issuing the first amount of first tokens. The first token may be a token for which the electronic device 10 or a game server including the electronic device 10 has a right to issue. Further, a second token may be a token that cannot be withdrawn but can function as currency that can be exchanged in the game platform. For example, a player may purchase a character or an item for participating in the game by using the second token in the game platform.

The electronic device 10 may transmit information about the first token provided to each of the first players to a terminal of each of the first players, and may transmit information about the second token provided to each of the second players to a terminal of each of the second players.

In an existing game system, since tokens are issued and provided to players as a reward for participating in a game, inflation may occur in which the value of the tokens gradually decreases as the tokens are issued. However, if tokens are provided as a reward to a plurality of players participating in the game, the electronic device 10 newly issues a first amount of first tokens provided to the first players who are winners and converts the first amount of first tokens among the participation fees of the second players who are losers into non-withdrawable tokens, and thus the value of the newly issued first tokens may be maintained and inflation may be prevented.

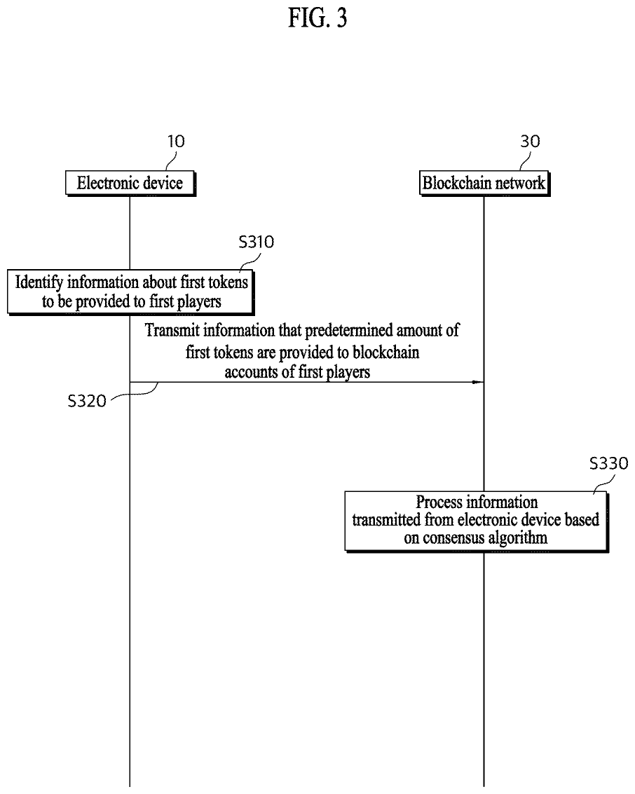

FIG. 3 is a flowchart illustrating an example embodiment in which an electronic device provides a first token to a first player using a blockchain network.

In operation S310, the electronic device 10 may identify information about the first tokens to be provided to the first players and information about blockchain accounts of the first players. The information about the first tokens may include information about the amount of first tokens. The electronic device 10 may obtain information about the blockchain accounts of the first players from terminals of the first players.

In operation S320, the electronic device 10 may transmit information that a predetermined (or selected) amount of the first tokens are provided to the blockchain accounts of the first players to the blockchain network 30 based on the information identified in operation S310. Specifically, the electronic device 10 may store the information that the predetermined (or selected) amount of the first tokens are provided to the first players' blockchain accounts in the internal database or provide the information to the terminals of the first players, and meanwhile, the electronic device 10 may transmit the information to the blockchain network 30. For example, the electronic device 10 may generate a transaction including information that the predetermined (or selected) amount of first tokens are provided to the blockchain accounts of the first players, and may transmit the generated transaction to at least one node of the blockchain network 30.

In operation S330, the blockchain network 30 may process the information transmitted in S320 based on the consensus algorithm. According to an example embodiment, the blockchain network 30 may record or store the information transmitted in operation S320 based on the consensus algorithm. The blockchain network 30 may record or store the transaction including information a predetermined (or selected) amount of first tokens are provided to a blockchain account of a first player in the form of a block based on the consensus algorithm. Further, the blockchain network 30 may provide information that the transaction is recorded to at least one of the electronic device 10 and the terminal of the first player. According to an example embodiment, the blockchain network 30 may perform functions such as issuance of tokens or transmission of tokens.

Further, the electronic device 10 may transmit information about play in a game of each of the plurality of players to the blockchain network 30, and the blockchain network 30 may record or store the transmitted information based on the consensus algorithm.

Therefore, since the electronic device 10 may record information about the first tokens provided to the first player by using the blockchain network 30 or information about play in a game of each of the plurality of players, integrity and transparency of recorded information may be guaranteed.

FIG. 4 is a flowchart illustrating an example embodiment in which an electronic device provides a second token to a second player using a blockchain network.

In operation S410, the electronic device 10 may identify information about the second tokens to be provided to a second player and information about a blockchain account of the second player. The information about the second tokens may include information about the amount of second tokens. The electronic device 10 may obtain information about the blockchain account of the second player from a terminal of the second player.

In operation S420, the electronic device 10 may transmit, to the blockchain network 30, information that the predetermined (or selected) amount of first tokens cannot be withdrawn from the blockchain account of the second player based on the information identified in operation S310. According to an example embodiment, the electronic device 10 may generate a transaction including the information that the predetermined (or selected) amount of first tokens are locked up for a certain period of time or permanently in the blockchain account of the second player, and transmit the transaction to at least one node of the blockchain network 30.

In operation S430, the blockchain network 30 may process information transmitted in operation S420 based on the consensus algorithm. According to an example embodiment, the blockchain network 30 may record or store the information transmitted in operation S420 based on the consensus algorithm. Based on the consensus algorithm, the blockchain network 30 may record or store the transaction including the information that the predetermined (or selected) amount of first tokens are locked up for a certain period of time or permanently in the blockchain account of the second player in the form of a block. The electronic device 10 may recognize a locked-up first token as a second token, and may provide the locked-up first token as the second token to the second player. Further, the blockchain network 30 may provide the information that the transaction is recorded to at least one of the electronic device 10 and the terminal of the second player.

Based on the information about each blockchain account of the players, the electronic device 10 may periodically update information about the amount of first tokens, the amount of second tokens and the amount of third tokens held by each of the players, and the electronic device 10 may provide the updated information to each terminal of the players.

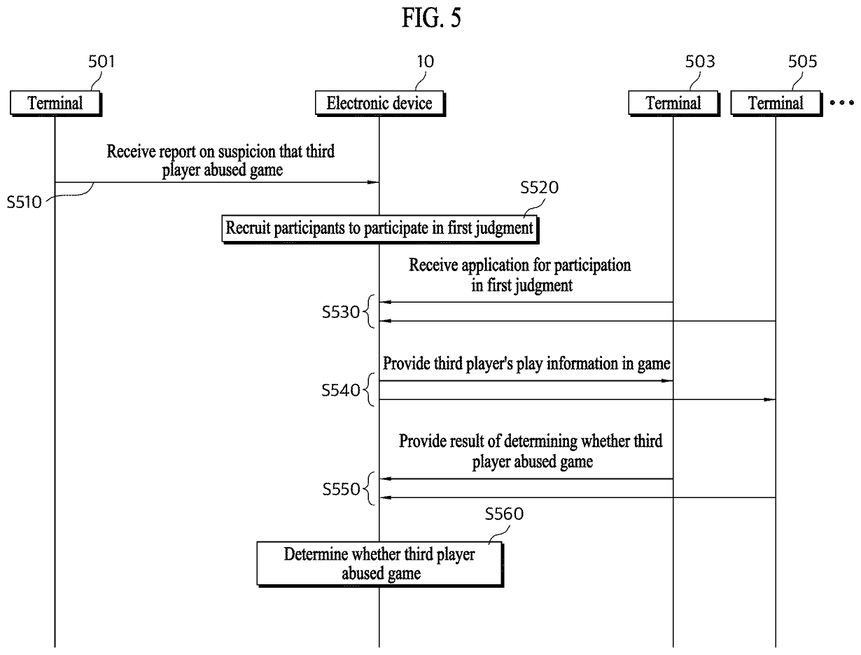

FIG. 5 is a flowchart illustrating an example embodiment in which an electronic device determines whether a player abused a game.

In operation S510, the electronic device 10 may receive, from a terminal 501 of a fourth player, a report on suspicion that the third player abused the game among the plurality of players participated in the game. Specifically, the electronic device 10 may not provide the first tokens or the second tokens as a reward to the plurality of players who participated in the game immediately after the game play is finished, and the electronic device 10 may receive the report on suspicion that the third player abused the game from the terminal 501 of the fourth player among the plurality of players for a preset period of time after the game play is ended. Here, the abuse may indicate cheating to take illegal profits in games. Specifically, the abuse may indicate obtaining undue benefits, such as elevating a ranking in the game, by manipulating the results of a match using a method not allowed in the game or loopholes in the game system. For example, the abuse may include an act of using an illegal program that is not permitted during game play, an act of cheating and an act of bad manners. According to an example embodiment, the electronic device 10 may receive, from the terminal 501 of the fourth player, information (for example, evidence) on whether the third player abused the game for any reason upon receiving the report on the suspicion.

In operation S520, the electronic device 10 may recruit participants to participate in a first judgment for determining whether the third player abused the game in response to receiving the report on suspicion that the third player abused the game in operation S510.

According to an example embodiment, the electronic device 10 may recruit participants to participate in the first judgment among game users (for example, players participating in other games) other than the players who participated in the game which is the target of the first judgment. For example, the electronic device 10 may inquire whether to participate in the first judgment with each terminal of the game users.

In operation S530, the electronic device 10 may receive an application for participation in the first judgment from each of terminals 503 and 505 of first participants.

In operation S540, the electronic device 10 may provide the third player's play information in the game to each of the terminals 503 and 505 of the first participants. For example, the electronic device 10 may transmit a video showing how the third player played in the game to each of the terminals 503 and 505 of the first participants. According to an example embodiment, the electronic device 10 may transmit play information for a play section pointed out by the fourth player among the entire play section of the game to each of the terminals 503 and 505 of the first participants, and may transmit evidence provided from the terminal 501 of the fourth player to each of the terminals 503 and 505 of the first participants.

In operation S550, the electronic device 10 may receive, from each of the terminals 503 and 505 of the first participants, a result of determining whether the third player abused the game. For example, the electronic device 10 may receive a determination result from the terminal 503 of one first participant, and may receive a determination result from the terminal 505 of another first participant that the third player did not abuse the game. For example, a first participant may input a result of determination as to whether the third player abused the game to a terminal, and the information on the input determination result may be transmitted from the terminal to the electronic device 10.

In operation S560, the electronic device 10 may determine whether the third player abused the game based on determination results received in S550. In other words, as a result of the first judgment, the electronic device 10 may determine whether the third player abused the game in the course of playing the game. According to an example embodiment, the electronic device 10 may determine whether the third player abused the game according to a majority vote based on the determination result of each of the first participants. In other words, if there are more participants who determined that the third player abused the game than participants who determined otherwise among the first participants, the electronic device 10 may determine that the third player abused the game, and if there are more participants who determined that the third player did not abuse the game than the participants who determined otherwise among the first participants, the electronic device 10 may determine that the third player did not abuse the game.

If it is determined that the third player abused the game, the electronic device 10 may distribute a predetermined (or selected) amount of tokens from the participation fee of the third player to the fourth player and at least one first participant who determined that the third player abused the game among the first participants. Further, if it is determined that the third player did not abuse the game, the electronic device 10 may distribute a predetermined (or selected) amount of tokens from the participation fee of the fourth player to the third player and at least one first participant who determined that the third player did not abuse the game among the first participants.

After it is determined whether the third player abused the game, the electronic device 10 may provide the first tokens to the first players who are winners and the second tokens to the second players who are losers in the game. If it is determined that the third player abused the game in the first judgment, the electronic device 10 may not provide the first token to the third player if the third player is included in the first players.

The electronic device 10 may transmit a transaction including information about tokens provided to the third player, the fourth player and the first participants according to a result of the first judgment to the blockchain network, and the blockchain network may record or store forwarded transactions.

The electronic device 10 may perform staking on the participation fee of the third player and the participation fee of the fourth player in the first judgment progress.

Therefore, as the electronic device 10 introduces a system regarding determination on whether a specific player abused the game according to a report on suspicion, it is possible for a plurality of players to monitor each other and play the game fairly. Specifically, the electronic device 10 determines whether or not a specific player abused the game in the judgment based on the determination results of the participants, thereby enabling a more objective determination of whether the specific player abused the game. Further, as the participation fee for game is provided to the player who reported the suspicion or the player who received the suspicion according to the determination result, a plurality of players may be prevented from indiscriminately reporting suspicion. The participation fee for the game is provided to the participants according to the judgment result, so the participation rate of the participants may be increased, and the participants may be motivated to make more fair judgments.

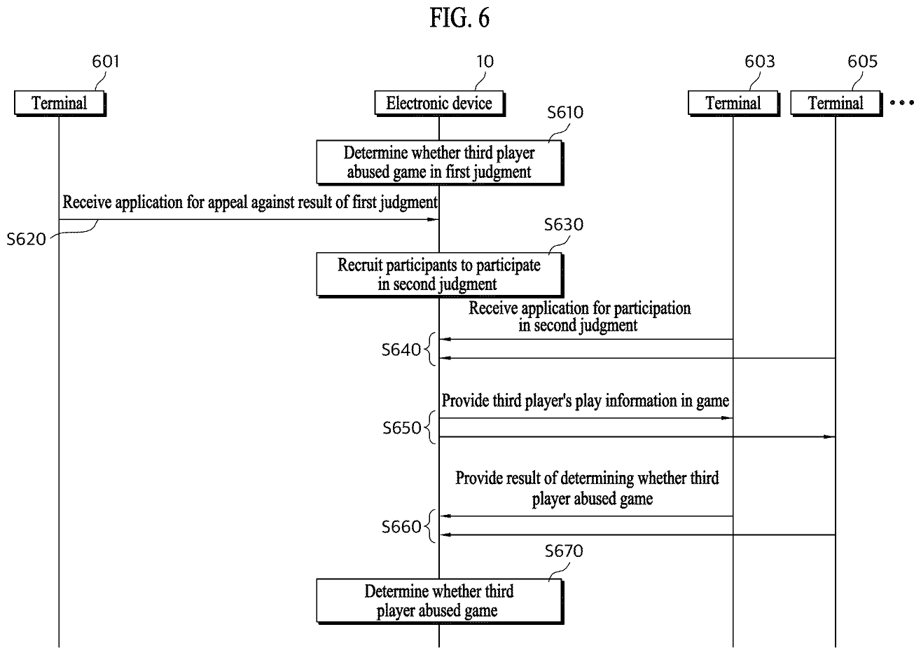

FIG. 6 is a flowchart illustrating an example embodiment in which an electronic device determines whether a player abused the game.

In operation S610, the electronic device 10 may determine whether the third player abused the game in the first judgment. For example, as in operation S560 of FIG. 5, the electronic device 10 may determine whether the third player abused the game based on the determination result of each of the participants.

In operation S620, the electronic device 10 may receive an application for appeal against the result of the first judgment from a terminal 601. The electronic device 10 may receive the application for appeal against the result of the first judgment from the terminal 601 within a preset period of time after the determination of the first judgment. The terminal 601 may be at least one terminal among terminals of the third player, the fourth player who reported on suspicion that the third player abused the game in the first judgment and the first participants participated the first judgment. According to an example embodiment, if it is determined that the third player abused the game in the first judgment, the at least one terminal 601 among the terminals of the third player and at least one first participant who determined that the third player did not abuse the game may transmit the application for appeal against the result of the first judgment to the electronic device 10. Further, at least one of the fourth player and at least one first participant who determined that the third player abused the game, as the opponent against the dissent, may transmit an application for participation in a second judgment, which is a judgment against the result of the first judgment, to the electronic device 10 through a terminal. According to another example embodiment, if is determined that the third player did not abuse the game in the first judgment, at least one terminal 601 among the terminals of the fourth player and at least one first participant who determined that the third player abused the game may transmit the application for appeal against the result of the first judgment to the electronic device 10. Further, at least one of the third player and at least one first participant who determined that the third player did not abuse the game, as the opponent against the dissent, may transmit an application for participation in the second judgment to the electronic device 10 through a terminal.

The electronic device 10 may receive, from the terminal 601, information regarding the reason for appeal against the determination of the first judgment upon receiving the application for appeal. For example, the reason for appeal against the determination of the first judgment may be information about why the third player abused the game (for example, evidence) or information about why the third player did not abuse the game (for example, evidence), and the reason may be information about why the determination of the first judgment is not appropriate. Further, if the application for participation in the second judgment is received in the stance of the opponent against the dissent, the electronic device 10 may receive information about why the determination of the first judgment is valid from a terminal.

The terminal 601 may transmit the application for appeal against the result of the first judgment to the electronic device 10 on condition of a predetermined (or selected) application fee. A predetermined (or selected) application fee may be a predetermined (or selected) number of tokens. For example, the predetermined (or selected) application fee may be a predetermined (or selected) amount of first tokens and/or a predetermined (or selected) amount of third tokens which are a stable coin. Further, the terminal may transmit an application for participation in the second judgment to the electronic device 10 in the stance of the opponent against the dissent, subject to the predetermined (or selected) application fee. According to an example embodiment, the electronic device 10 may perform staking for the predetermined (or selected) application fee, the third player's game participation fee and the fourth player's game participation fee, while the first and second judgments are in progress.

In operation S630, the electronic device 10 may recruit participants to participate in the second judgment for determining whether the third player abused the game.

According to an example embodiment, the electronic device 10 may recruit participants to participate in the second judgment among game users others than players participated in the game which is the target of the second judgment. For example, the electronic device 10 may inquire whether to participate in the second judgment with each terminal of the game users.

In operation S640, the electronic device 10 may receive an application for participation in the second judgment from each of terminals 603 and 605 of second participants.

In operation S650, the electronic device 10 may provide the third player's play information in the game to each of the terminals 603 and 605 of the second participants. For example, the electronic device 10 may transmit a video showing how the third player played in the game to each of the terminals 603 and 605 of the second participants. Further, the electronic device 10 may transmit, to each of the terminals 603 and 605, the information regarding the reason for appeal against the result of the first judgment when the application for appeal against the result of the first judgment is received in operation S620. Further, the electronic device 10 may transmit, to each of the terminals 603 and 605, information regarding the reason why the determination of the first judgment is valid when the application for participation in the second judgment is received.

In operation S660, the electronic device 10 may receive, from each of terminals 603 and 605 of the second participants, a result of determining whether the third player abused the game. Specifically, the second participants may determine whether the third player abused the game based on the information transmitted from operation S650, and may transmit determination results to the electronic device 10 through the terminals 603 and 605. For example, the electronic device 10 may receive a determination result from the terminal 603 of one second participant that the third player abused the game, and may receive the determination result from the terminal 605 of another second participant that the third player did not abuse the game.

In operation S670, the electronic device 10 may determine whether the third player abused the game based on a determination result received in operation S660. According to an example embodiment, the electronic device 10 may determine whether the third player abused the game according to a majority vote based on the determination result of each of the second participants participating in the second judgment. In other words, if there are more second participants who determined that the third player abused the game than the second participants who determined otherwise among the second participants who participated in the second judgment, the electronic device 10 may determine that the third player abused the game, and if there are more second participants who determined that the third player did not abuse the game than the second participants who determined otherwise among the second participants who participated in the second judgment, the electronic device 10 may determine that the third player did not abuse the game.

If it is determined that the third player abused the game in the second judgment, the electronic device 10 may distribute a predetermined (or selected) amount of tokens from the participation fee for the game of the third player and a predetermined (or selected) amount of tokens from the application fee for the second judgment (for example, the application fee of the third player or application fee of at least one first participant who determined that the third player did not abuse the game) to the fourth player, at least one first participant who determined that the third player abused the game and at least one second participant who determined that the third player abused the game. Further, if it is determined that the third player did not abuse the game in the second judgment, the electronic device 10 may distribute a predetermined (or selected) amount of tokens from the participation fee for the game of the fourth player and a predetermined (or selected) amount of tokens from the application fee for the second judgment (for example, the application fee of the fourth player or application fee of at least one first participant who determined that the third player abused the game) to the third player, at least one first participant who determined that the third player did not abuse the game and at least one second participant who determined that the third player did not abuse the game.

After it is determined whether the third player abused the game in the second judgment, the electronic device 10 may provide first tokens to the first players who are winners and second tokens to the second players who are losers in the game. If it is determined that the third player abused the game in the second judgment, the electronic device 10 may not provide the first tokens to the third player if the third player is included in the first players.

According to the result of the second judgment, the electronic device 10 may transmit a transaction including information about tokens provided to the third player, the fourth player, the first participants and the second participants to the blockchain network, and the blockchain network may record or store the forwarded transaction.

Therefore, the electronic device 10 may enable a more fair judgment as to whether a specific player abused the game by introducing a system for the first judgment and the second judgment that is against the result of the first judgment.

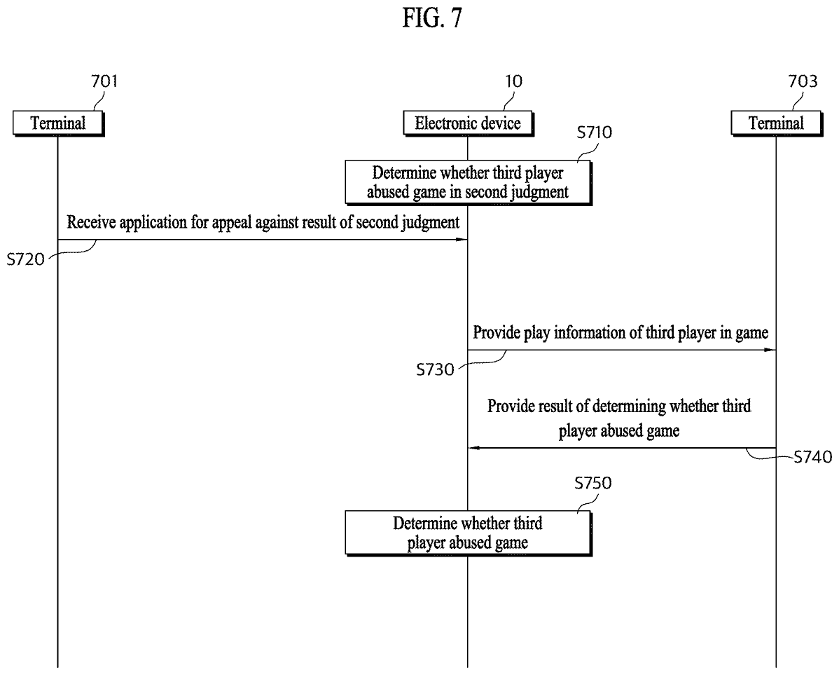

FIG. 7 is another flowchart illustrating an example embodiment in which an electronic device determines whether a player abused the game.

In operation S710, the electronic device 10 may determine whether the third player abused the game in the second judgment. For example, as in operation S670 of FIG. 6, the electronic device 10 may determine whether the third player abused the game based on the determination result of each of the second participants in the second judgment.

In operation S720, the electronic device 10 may receive an application for appeal against the result of the second judgment from a terminal 701. The electronic device 10 may receive the application for appeal against the result of the second judgment from the terminal 701 within a preset period of time after the determination is made in the second judgment. The terminal 701 may be at least one terminal among terminals of the third player, the fourth player who reported the suspicion that the third player abused the game and the participants who participated in the first judgment or the second judgment. According to an example embodiment, if it is determined that the third player abused the game in the second judgment, at least one terminal 601 among terminals of the third player, at least one first participant who determined that the third player did not abuse the game and at least one second participant who determined that the third player did not abuse the game, may transmit the application for appeal against the result of the second judgment. Further, at least one among the fourth player, at least one first participant who determined that the third player abused the game and at least one second participant who determined that the third player abused the game, as the opponent against the dissent, may transmit an application for participation in a third judgment, which is a judgment against the result of the second judgment, to the electronic device 10 through a terminal. According to another example embodiment, if it is determined that the third player did not abuse the game in the second judgment, at least one terminal 601 among terminals of the fourth player, at least one first participant who determined that the third player played the game that is abusive and at least one second participant who determined that the third player played the game that is abusive, may transmit the application for appeal against the result of the second judgment to the electronic device 10. Further, at least one among the third player, at least one first participant who determined that the third player did not abuse the game and at least one second participant who determined that the third player did not abuse the game, as the opponent against the dissent, may transmit an application for participation in the third judgment to the electronic device 10.

Upon receiving the application for appeal, the electronic device 10 may receive information about the reason for appeal against the result of the first judgment or the second judgment from the terminal 701. For example, the reason for appeal may be information on why the third player abused the game (for example, evidence) or information on why the third player did not abuse the game (for example, evidence), or may be information about why the determination of the first judgment or the determination of the second judgment is not appropriate for any reason. Further, when receiving the application for participation in the third judgment from the position of the opponent against the dissent, the electronic device 10 may receive information about reason why the determination of the second judgment is valid from a terminal.

The terminal 701 may transmit, to the electronic device 10, an application for appeal against the result of the second judgment (that is, a request for proceeding with the third judgment) on condition of a predetermined (or selected) application fee. The predetermined (or selected) application fee may be a predetermined (or selected) amount of tokens. For example, the predetermined (or selected) application fee may be a predetermined (or selected) amount of withdrawable first tokens and/or a predetermined (or selected) amount of third tokens which are a stable coin. Further, the terminal may transmit, to the electronic device 10, the application for participation in the third judgment in the stance of the opponent against the dissent, on condition of the predetermined (or selected) application fee. According to an example embodiment, during the first judgment, the second judgment and the third judgment, the electronic device 10 may perform staking on the application fee for the second judgment, the application fee for the third judgment, the participation fee for the game of the third player and the participation fee for the game of the fourth player.

In operation S730, the electronic device 10 may provide play information of the third player in the game to a terminal 703 of a manager. Further, the electronic device 10 may transmit, to the terminal 703, information regarding the reason for appeal received when the application for appeal was received in operation S720. Further, the electronic device 10 may transmit, to the terminal 703, information regarding the reason why the determination of the second judgment received when the application for participation in the third judgment was received is valid. For example, the manager may be an administrator who operates a server, and there may be a plurality of terminals 703.

In operation S740, the electronic device 10 may receive a determination result on whether the third player abused the game from the terminal 703 of the manager. For example, the manager may input the determination result on whether the third player abused the game based on the information transmitted in operation S730, to the terminal 703, and the information on the input determination result may be transmitted from the terminal 703 to the electronic device 10.

In operation S750, the electronic device 10 may determine whether the third player abused the game as a result of the third judgment based on the determination result received in operation S740. According to an example embodiment, if the number of the terminal 703 of the manger is singular, the electronic device 10 may determine whether the third player abused the game according to the determination result received by the terminal 703 of the manager. According to another example embodiment, if the number of terminals 703 of the manger is plural, the electronic device 10 may determine whether the third player abused the game according to a majority vote based on the determination result of each of the terminals 703 of the manager.

If it is determined that the third player abused the game in the third judgment, the electronic device 10 may distribute a predetermined (or selected) amount of tokens from the participation fee for the game of the third player, a predetermined (or selected) amount of tokens from the application fee for the second judgment (for example, the application fee of the third player, and/or the application fee of at least one first participant who determined that the third player did not abuse the game) and a predetermined (or selected) amount of tokens from the application fee for the third judgment (for example, the application fee of the third player, the application fee of at least one first participant who determined that the third player did not abuse the game, and/or the application fee of at least one second participant who determined that the third player did not abuse the game) to the fourth player, at least one first participant who determined that the third player abused the game and to at least one second participant who determined that the third player abused the game. If it is determined that the third player did not abuse the game in the third judgment, the electronic device 10 may distribute a predetermined (or selected) amount of tokens from the participation fee for the game of the fourth player, a predetermined (or selected) amount of tokens from the application fee of the second judgment (for example, the application fee of the fourth player, and/or the application fee of at least one first participant who determined that the third player abused the game) and a predetermined (or selected) amount of tokens from the application fee of the third judgment (for example, the application fee of the fourth player, the application fee of at least one first participant who determined that the third player abused the game, and/or the application fee of at least one second participant who determined that the third player abused the game) to the third player, at least one first participant who determined that the third player did not abuse the game and to at least one second participant who determined that the third player did not abuse the game.

Therefore, the electronic device 10 may enable a more fair judgment as to whether a specific player abused the game by introducing a system for the first judgment, the second judgment that is against the result of the first judgment and the third judgment that is against the result of the second judgment.

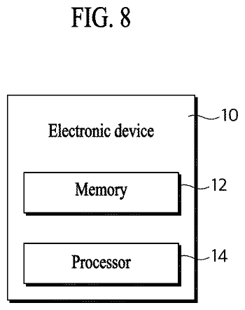

FIG. 8 is a block diagram of an electronic device.

The electronic device 10 may be used to implement any system or method described in the present disclosure. For example, the electronic device 10 may be configured to be used as a data server, a web server, a portable computing device, a personal computer, a tablet computer, a workstation, a mobile phone and a smart phone, or the electronic device 10 may be configured to be used as any electronic device including any other devices described below.

The electronic device 10 may include a memory 12 and a processor 14. Additionally, the electronic device 10 may include other devices that may be connected to the electronic device 10 through one or more ports (for example, a universal serial bus (USB), a headphone jack, a lightning connector and a thunderbolt connector). A device connectable to the electronic device 10 may include a plurality of ports configured to receive a fiber optic connector. The illustrated configurations of the electronic device 10 are only example embodiments for the purpose of illustrating specific embodiments of the device. Only components related to the example embodiments of the electronic device 10 of the present disclosure are illustrated. Therefore, it is apparent to those skilled in the art that other general-purpose components other than the illustrated components of the electronic device 10 may be further included.

The processor 14 may be used to cause the electronic device 10 to provide the operations and functions of any of the example embodiments described in the present disclosure. For example, the processor 14 generally controls the electronic device 10 by executing programs stored in the memory 12 in the electronic device 10. The processor 14 may be implemented as a central processing unit (CPU), a graphics processing unit (GPU) or an application processor (AP) included in the electronic device 10. However, the processor 14 is not limited thereto.

The memory 12 is hardware for storing various data processed in the electronic device 10, and may store data processed and data to be processed through the processor 14 in the electronic device 10. Further, the memory 12 may store a program and data that may provide function of at least one example embodiment of the present disclosure, and the memory 12 may store applications (programs, code modules and instructions) that may provide functions of example embodiments of the present disclosure and drivers. The memory 12 may include random access memory (RAM), such as dynamic random access memory (DRAM), static random access memory (SRAM), read-only memory (ROM), electrically erasable programmable read-only memory (EEPROM), CD-ROM, Blu-ray or other optical disk storage, hard disk drive (HDD), solid state drive (SSD) or flash memory.

According to an example embodiment, the electronic device 10 may further include a communication device, and in the electronic device 10, the communication device may transmit data to another device by the electronic device 10, or may function as an interface capable of receiving data from another device. Transmitting and receiving data may be performed wirelessly as well as wired. The communication device may be configured as a wired communication module that accesses the Internet or the like through the local area network (LAN), a mobile communication module for transmitting and receiving data by accessing a mobile communication network through a mobile communication base station, a short-distance communication module using the wireless local area network (WLAN) communication method such as Wi-Fi or the wireless personal area network (WPAN) communication method such as Bluetooth and ZigBee, the satellite communication module using the global navigation satellite system (GNSS) such as the global positioning system (GPS), or a combination thereof.

The processor 14 may receive an application to participate in a game conditional on a predetermined (or selected) participation fee from terminals of a plurality of players. The participation fee may include a predetermined (or selected) amount of first tokens and a predetermined (or selected) amount of third tokens which is a stable coin.

The processor 14 may identify information about the plurality of players participating in the game.

Based on the play results in each game of the plurality of players, the processor 14 may identify first players who are winners and second players who are losers among the plurality of players. The ratio of the winners and the losers among the plurality of players may be settable by a user.

The processor 14 may provide the first players with a first amount of withdrawable first tokens, and provide the second players with the first amount of non-withdrawable second tokens. The processor 14 may distribute the first amount of first tokens to the first players based on the rankings of the first players according to the play result in the game, and may provide a predetermined (or selected) amount of second tokens to each of the second players. The processor 14 may transmit information about first tokens provided to each of the first players to terminals of each of the first players, and transmit information about second tokes provided to each of the second players to each of the second players. The first amount may be settable by a user.

The processor 14 may convert the first amount of first tokens among the participation fees of the second players into non-withdrawable tokens. In other words, the processor 14 may convert the first amount of first tokens out of the entire participation fees of the second players into non-withdrawable tokens. The processor 14 may transmit information that the predetermined (or selected) amount of the first tokens are locked up in a blockchain account of each of the second players to the blockchain network. Then, the blockchain network may record the transmitted information based on the consensus algorithm.

The processor 14 may transmit information about play of each of the plurality of players in the game, and information about the first tokens provided to each of the first players to the blockchain network. Then, the blockchain network may record the transmitted information based on the consensus algorithm.

The processor 14 may receive, from the terminal of the fourth player, a report on suspicion that the third player abused the game among the plurality of players within a preset period of time after the end of the game play. The processor 14 may recruit participants to participate in the first judgment for determining whether the third player abused the game. The processor 14 may provide the play information of the third player in the game to each of terminals of the first participants participating in the first judgment. The processor 14 may receive a determination result as to whether the third player abused the game from each of the terminals of the first participants. The processor 14 may determine whether the third player in the game abused the game based on the determination result, as a result of the first judgment.

If it is determined that the third player abused the game, the processor 14 may distribute a predetermined (or selected) amount of tokens from the participation fee of the third player to the fourth player and at least one first participant who determined that the third player abused the game among the first participants, and if it is determined that the third player did not abuse the game, the processor 14 may distribute the predetermined (or selected) amount tokens from the participation fee of the fourth player to the third player and at least one first participant who determined that the third player did not abuse the game among the first participants.

The processor 14 may receive an application for appeal against the result of the first judgment from at least one terminal among the terminals of the third player, the fourth player and the first participants. The processor 14 may recruit participants to participate in the second judgment, which is a judgment against the result of the first judgment. The processor 14 may provide the play information of the third player in the game to each of terminals of the second participants participating in the second judgment. The processor 14 may receive a determination result as to whether the third player abused the game from each of the terminals of the second participants. The processor 14 may determine whether the third player abused the game as a result of the second judgment based on determination results received from the terminals of the second participants.

The processor 14 may receive an application for appeal against the result of the second judgment from at least one among the third player, the fourth player, the first participants and the second participants. The processor 14 may provide the play information of the third player in the game to the manager's terminal. The processor 14 may receive a result of determining whether the third player abused the game from the manager's terminal. The processor 14 may determine whether the third player abused the game based on the determination result received from the manager's terminal.

A device according to the above described example embodiments may include a processor, a memory for storing and executing program data, permanent storage such as disk drives, communication ports to communicate with external devices and user interface devices such as touch panels, keys and buttons. Methods implemented as software modules or algorithms are computer readable codes or program instructions executable on the processor, and may be stored on a computer-readable recording medium. Here, the computer-readable recording medium includes a magnetic storage medium (for example, a read-only memory (ROM), a random-access memory (RAM), a floppy disk and a hard disk) and an optically readable medium (for example, a CD-ROM, a digital versatile disc (DVD)). The computer-readable recording medium may be distributed among network-connected computer systems, so that a computer-readable code may be stored and executed in a distributed manner. The medium may be readable by a computer, stored in a memory, and executed on a processor.

The example embodiments may be represented by functional block elements and various processing steps. The functional blocks may be implemented in any number of hardware and/or software configurations that perform specific functions. For example, an example embodiment may adopt integrated circuit configurations, such as memory, processing, logic and look-up table, that may execute various functions by the control of one or more microprocessors or other control devices. Similar to that elements may be implemented as software programming or software elements, the example embodiments may be implemented in a programming or scripting language such as C, C++, Java, assembler, etc., including various algorithms implemented as a combination of data structures, processes, routines, or other programming constructs. Functional aspects may be implemented in an algorithm running on one or more processors. Further, the example embodiments may adopt the existing art for electronic environment setting, signal processing, and/or data processing. Terms such as “mechanism,” “element,” “means” and “configuration” may be used broadly and are not limited to mechanical and physical elements. The terms may include the meaning of a series of routines of software in association with a processor or the like.

The above-described example embodiments are merely examples, and other embodiments may be implemented within the scope of the claims to be described later.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of providing an online game service, comprising:
receiving an application to participate in a game conditional on a participation fee from terminals of a plurality of players;
identifying information about the plurality of players participating in the game;
identifying first players who are winners and second players who are losers from among the plurality of players based on a play result of each of the plurality of players in the game; and
providing the first players with a first amount of withdrawable first tokens, and providing the second players with the first amount of non-withdrawable second tokens,
wherein the providing comprises converting the first amount of first tokens among participation fees of the second players into non-withdrawable tokens.

2. The method of claim 1, wherein the providing comprises distributing the first amount of first tokens to the first players based on rankings of the first players according to the play result in the game, and providing an identical amount of second tokens to each of the second players.

3. The method of claim 1, wherein the providing comprises transmitting information about first tokens provided to each of the first players to each terminal of the first players, and transmitting information about the second tokens provided to each of the second players to each terminal of the second players.

4. The method of claim 1, wherein the converting comprises transmitting information that a selected amount of first tokens are locked-up in each blockchain account of the second players to a blockchain network, and
wherein the blockchain network records the transmitted information based on a consensus algorithm.

5. The method of claim 1, wherein the providing comprises transmitting information about a play in the game of each of the plurality of players and information about first tokens provided to each of the first players to a blockchain network, and
wherein the blockchain network records the transmitted information based on a consensus algorithm.

6. The method of claim 1, wherein the participation fee comprises a selected amount of first tokens and a selected amount of third tokens that are a stable coin.

7. The method of claim 1, wherein a ratio of winners and losers among the plurality of players and the first amount are settable by a user.

8. The method of claim 1, further comprising:
receiving a report on suspicion that a third player abused the game among the plurality of players from a terminal of a fourth player within a preset period of time after an end of play of the game;
recruiting participants to participate in a first judgment to determine whether the third player abused the game;
providing play information in the game of the third player to each of terminals of first participants participating in the first judgment;
receiving a determination result as to whether the third player abused the game from each of the terminals of the first participants; and
determining whether the third player abused the game as a result of the first judgment based on the determination result.

9. The method of claim 8, further comprising:
based on determining that the third player abused the game, distributing a selected amount of tokens from a participation fee for the game of the third player to the fourth player and at least one first participant who determined that the third player abused the game among the first participants; and
based on determining that the third player did not abuse the game, distributing a selected amount of tokens from a participation fee for the game of the fourth player to the third player and at least one first participant who determined that the third player did not abuse the game among the first participants.

10. The method of claim 8, further comprising:
receiving an application for appeal against the result of the first judgment from at least one terminal among terminals of the third player, the fourth player and the first participants;
recruiting participants to participate in a second judgment, which is a judgment against the result of the first judgment;
providing play information of the third player in the game to each of terminals of second participants participating in the second judgment;
receiving a determination result as to whether the third player abused the game from each of the terminals of the second participants; and
determining whether the third player abused the game as a result of the second judgment based on the determination result received from the terminals of the second participants.

11. The method of claim 10, comprising:
receiving an application for appeal against the result of the second judgment from at least one terminal among terminals of the third player, the fourth player, the first participants and the second participants;
providing play information of the third player in the game to a terminal of a manager;
receiving a determination result as to whether the third player abused the game from the terminal of the manager; and
determining whether the third player abused the game based on the determination result received from the terminal of the manager.

12. A computer-readable non-transitory recording medium recording a program for executing the method of claim 1 on a computer.

13. An electronic device for providing an online game service, comprising:
a memory in which at least one program is stored; and
a processor, configured to:
by executing the at least one program,
receive an application to participate in a game conditional on a participation fee from terminals of a plurality of players;
identify information about the plurality of players participating in the game;
identify first players who are winners and second players who are losers from among the plurality of players based on a play result of each of the plurality of players in the game; and
provide the first players with a first amount of withdrawable first tokens, and provide the second players with the first amount of non-withdrawable second tokens,
wherein the processor is configured to convert the first amount of first tokens among participation fees of the second players into non-withdrawable tokens.
